(19) United States
(12) Patent Application Publication
(10) Pub. No.: US 2010/0245584 A1
(43) Pub. Date: Sep. 30, 2010

(54) METHOD AND APPARATUS FOR CREATING A ZONE OF INTEREST IN A VIDEO DISPLAY

(75) Inventors: JOHN R. MINASYAN, FRESNO, CA (US); KSHAMA VIJAYAKUMAR, FREMONT, CA (US); JENNIFER L. JOYNER, CLOVIS, CA (US); NICHOLAS E. JOST, FRESNO, CA (US); TONY T. DICROCE, FRESNO, CA (US); DIMPLE D. JAIN, FRESNO, CA (US); THOMAS J. DISTLER, CLOVIS, CA (US)

Correspondence Address: PELCO INC., 3500 PELCO WAY, CLOVIS, CA, 93612, US

(73) Assignee: PELCO, INC., CLOVIS, CA (US)

(21) Appl. No.: 12/750,507

(22) Filed: Mar. 30, 2010

Related U.S. Application Data
(60) Provisional application No. 61/165,427, filed on Mar. 31, 2009.

(51) Int. Cl. H04N 7/18

(52) U.S. Cl. 348/159; 348/E07.085

(57) ABSTRACT

A method of creating a zone of interest in a video scene comprising the steps of capturing a video scene, transmitting a captured video scene over a network, receiving a captured video scene from the network, enabling a user to identify a portion of a captured video scene to be a zone of interest, replicating the portion of the captured video scene identified by the user as a zone of interest, rendering the video scene in a first window, and rendering the replicated portion of the captured video scene in a second window independent of the first window.

### CROSS-REFERENCE TO RELATED APPLICATION

This application is related to and claims the benefit of U.S. Provisional Patent Application Ser. No. 61/165,427 filed Mar. 31, 2009, entitled METHOD AND APPARATUS FOR CREATING A ZONE OF INTEREST IN A VIDEO DISPLAY, the entirety of which is incorporated herein by reference.

### STATEMENT REGARDING FEDERALLY SPONSORED RESEARCH OR DEVELOPMENT

N/A

### BACKGROUND OF THE INVENTION

This invention relates to surveillance systems and, in particular, to a workstation for use with a high-definition video stream from a megapixel camera or other device in a surveillance system.

Many video surveillance cameras incorporate an optical zoom feature, allowing the user to get a magnified view of a scene without physically repositioning the camera. In recent years, regular optical (lens-based) zooming has been enhanced by digital zoom capabilities, which extend the zoom capabilities through digital processing of the image. However, with standard definition cameras, the usefulness of digital zoom has been limited, because beyond a certain magnification, the picture degrades and pixilates so that the images are of limited utility.

With the introduction of high-definition cameras, a new opportunity presents itself The user can configure a single camera to monitor a wide field of view, then digitally zoom in on particular areas without suffering any deterioration in the picture quality. However, this benefit is reduced by the loss of access to the overall context for the selected detail. Furthermore, the user must set the zoom level each time he/she connects to the camera, and the zoomed portion cannot be stored for future sessions.

### SUMMARY OF THE INVENTION

In accordance with the present invention there is provided a method of creating a zone of interest in a video scene comprising the steps of capturing a video scene, transmitting a captured video scene over a network, receiving a captured video scene from the network, enabling a user to identify a portion of a captured video scene to be a zone of interest, replicating the portion of the captured video scene identified by the user as a zone of interest, rendering the video scene in a first window, and rendering the replicated portion of the captured video scene in a second window independent of the first window.

The present invention provides a method of creating a zone of interest in a field of view of a camera that allows independent view and management of the zone of interest in both live (a live scene being sent from a camera) and playback (a previously recorded scene being sent from a digital recorder) modes. The present invention makes it convenient to leverage the power of megapixel cameras to cover a large field of view while allowing a user to independently select certain areas of the scene for closer view without incurring additional network or processing load for supporting multiple cameras. In addition, the present invention addresses both of the issues that were not handled by the prior art systems. A user may select a section of video, set the desired zoom level, and save this view for use in future sessions. The settings for the independent window configuration, such as the site of the zone, size of zone, and zoom inside the zone, are saved in association with the user, camera, and workstation in both live and playback mode. The user may move the selected zone to another part of the screen, thus enabling the user to view simultaneously both the larger scene context as well as the scene detail. In addition, the cursor can be positioned in the zone of interest window, and the user can zoom in further and then pan and tilt within that window after zooming.

An example application in the surveillance field would be in a casino where the security operator needs to monitor a blackjack table. The camera could be configured to provide an overview of the table as a whole. Then the operator could create one zone of interest for each hand at the table, and one zone for the dealer. The overview shot of the blackjack table would not require magnification, but the zones showing each person's hand would be zoomed in so that it would be easy to distinguish which cards are being played.

The present invention allows a user to select several different portions of the scene and view them in separate, zoomable windows, making it easier for the user to pay attention to and perceive crucial details about events occurring in that area of interest. In addition, the present invention allows the user to save the zone information (the area of interest and the specified zoom level) and assign it a user friendly name, for easy retrieval each time that camera is accessed. Further, the present invention allows the user to observe simultaneously both the larger context of a scene as well as individual details of interest. An operator of a video security system can zoom in on (magnify) multiple selected portions of a scene while maintaining an overview of the scene.

The method and apparatus of the present invention do not tax the host processor; rather, processing is off-loaded to the graphics card whenever possible. The zone of interest windows created by the present invention have free floating, independent windows that can be resized or opened on a separate monitor without affecting the original video scene.

With the zone of interest method of the present invention, users have the full panoramic view of a scene, and then can zoom in on any specific location and see that portion in high definition detail. Users can select the desired number of zones in a scene and move them around anywhere on one or more monitors. This allows a user to see the whole scene while getting a detailed view of whatever interests the user. This is done with only one video stream from a megapixel camera so that there is no additional burden or overhead on the central or host processing unit, camera, or network resources.

Other advantages and applications of the present invention will be made apparent by the following detailed description of the preferred embodiment of the invention.

### BRIEF DESCRIPTION OF THE SEVERAL VIEWS OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a surveillance system for implementing the present invention.

FIG. 2 is a block diagram of an exemplary workstation for implementing the present invention.

FIG. 3 is an illustration of a screen display of the workstation according to the present invention.

FIG. 4 is an illustration of a screen display of the workstation according to the present invention.

FIG. 5 is an illustration of a screen display of the workstation according to the present invention.

FIG. 6 is an illustration of a screen display of the workstation according to the present invention.

FIG. 7 is an illustration of a screen display of the workstation according to the present invention.

FIG. 8 is an illustration of a screen display of the workstation according to the present invention.

FIG. 9 is an illustration of a screen display of the workstation according to the present invention.

FIG. 10 is an illustration of a screen display of the workstation according to the present invention.

FIG. 11 is an illustration of a screen display of the workstation according to the present invention.

FIG. 12 is an illustration of-a screen display of the workstation according to the present invention.

FIG. 13 is an illustration of a screen display of the workstation according to the present invention.

FIG. 14 is an illustration of a screen display of the workstation according to the present invention.

FIG. 15 is an illustration of a screen display of the workstation according to the present invention.

FIG. 16 is an illustration of a screen display of the workstation according to the present invention.

FIG. 17 is a block diagram of a one embodiment of a pipeline for implementing the present invention.

FIG. 18 is an illustration of the replication of a zone of interest in a scene.

FIG. 19 is a block diagram of a renderer object for implementing the present invention.

FIG. 20 is a block diagram of a pipeline object for implementing the present invention.

### DETAILED DESCRIPTION OF THE INVENTION

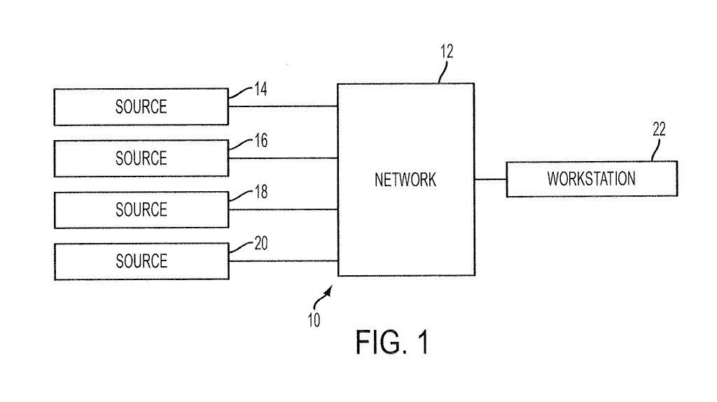

Referring to FIG. 1, a video surveillance system 10 has a network 12 which can be a closed network, local area network, or wide area network, such as the Internet. A plurality of video sources 14, 16, 18, and 20, which can be, for example, megapixel video cameras, digital video recorders or servers, are connected to network 12 to provide real-time high-definition video streams. Workstation 22, which can be, for example, a control point in surveillance system 10, a personal computer or a user logged into surveillance system 10 by means of a laptop computer, is connected to network 12. Sources 14, 16, 18, and 20 provide video streams to workstation 22 via network 12.

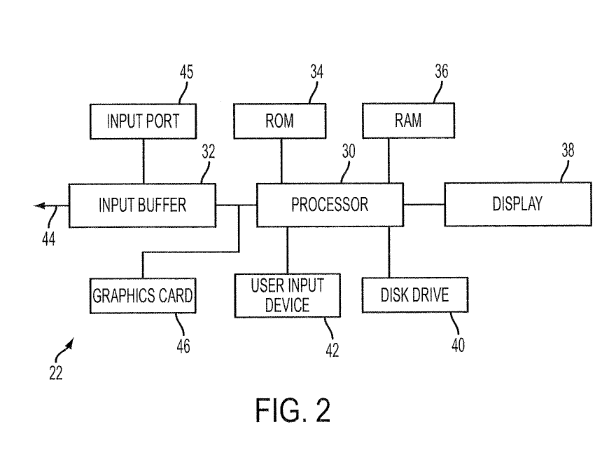

With reference to FIG. 2, an exemplary workstation of the present invention is shown in block diagram form. Workstation 22 has a central or host processor 30 which is connected to input buffer 32, ROM 34, RAM 36, video display 38, disk drive 40 and user input device 42. User input device 42 can be a keyboard, mouse, controller, or other suitable input device. Processor 30 implements algorithms and programs that are stored in ROM 34 or disk drive 40 in response to user input from user input device 42 and provides output signals to display 38. Input buffer 32 is connected to network 12 by line 44 to receive the video streams from sources 14, 16, 18, and 20 in FIG. 1. Input port 45, which can be, for example, a USB or FireWire port, can also provide video streams to input buffer 32. Workstation 22 also contains a graphics card 46 that contains its own processor and RAM. The programs and algorithms stored, for example, in disk drive 40 are loaded at run time to enable a user to configure workstation 22 in accordance with the present invention by interacting with the graphical user interface on display 38 with user input device 42.

A zone of interest is a region within a camera's field of view that can be set to a particular zoom level. To configure a zone of interest, a user clicks on the “Configure Zone of Interest” button from the video controls. This brings the user into configuration mode. A floating window appears on top of the video. This represents zone 1. The user may click and drag the window to a new position, use the scroll mouse to zoom in on the scene, and resize the window until he has selected the view that will allow him to see the details of interest. The zone is saved automatically. However, the user has the option to rename this zone, assigning it a user friendly name to make it easier to call up this zone in the future. The user may create, for example, up to 8 zones for each camera. Only one zone may be configured at a time. All other zones are marked with icons and outlined on the screen.

While configuring the zones of interest, a user may also want to move or “float” one or more zones to a different part of the screen. This helps the user by previewing how the zones will appear when in live monitoring mode and helping him identify where additional coverage is required. Floated zones may be arranged in any position on the primary monitor. They may also be shifted to a secondary monitor.

In live monitoring mode, to open a zone window, the user can either click the zone icon or right-click and select “Show” for the zone of interest. Each zone may be opened or closed individually, or all may be opened on the screen (or closed) simultaneously. Each time the user calls up the camera, the zones appear in the position where they were displayed the last time the user accessed that camera.

When a user removes the camera from his workspace, all associated zones are closed as well. The camera must be connected if the user wants to see the individual zones.

In live monitoring mode, a user may digitally zoom in on the zone of interest, i.e., the user may increase the magnification beyond the level set during the configuration. The user can then pan or tilt the digitally zoomed image to view the rest of the zone. However, when digitally zooming in this way, the user cannot pan or tilt beyond the perimeter of the configured zone, and this extra digital zooming will not be retained for future sessions. To increase the zoom level permanently, the user must return to configuration mode and save the changes there.

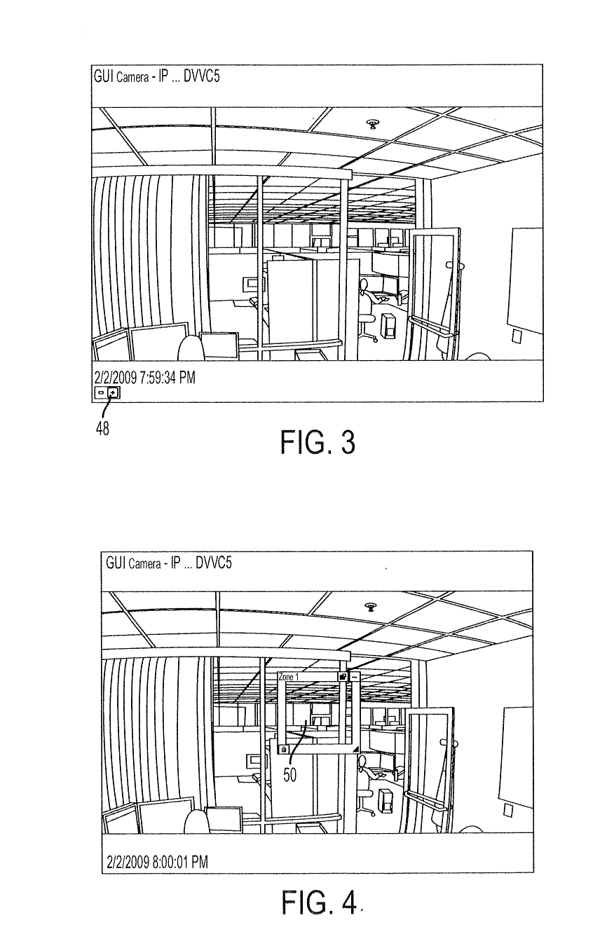

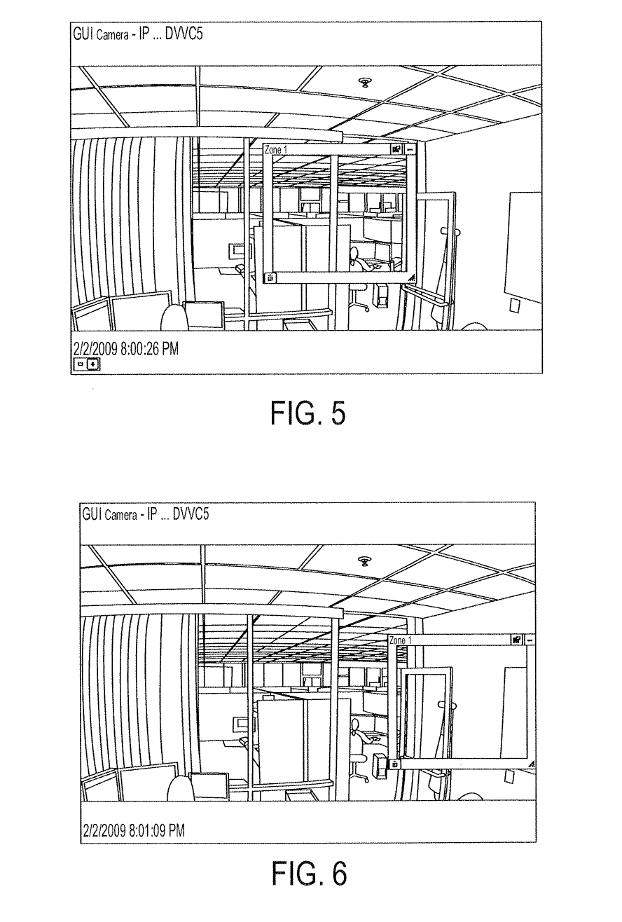

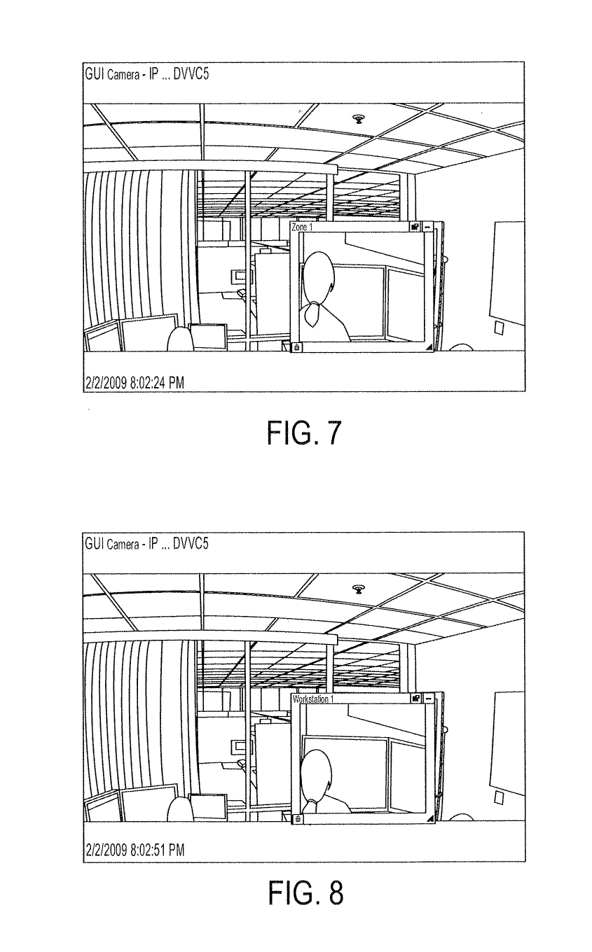

A user enters zone of interest mode by, for example, by moving a pointer to the Configure Zone of Interest button in a toolbar displayed on display 38 and then clicking the mouse button or other user input device 42. The configuration mode can be indicated by a visual indication such as a light blue border around the video frame. In one embodiment, zones of interest may only be configured when the camera is viewing the video scene in a 1×1 layout. To create a zone the user clicks the + button 48 in the video control toolbar as shown in the lower left-hand corner of the display illustrated in FIG. 3. A window 50 appears on top of the video as shown in the display illustrated in FIG. 4. Window 50 represents the zone of interest that is being configured. The zone of interest may be resized, to take in more of the scene as shown in the display illustrated in FIG. 5. The zone of interest may be moved to a different part of the screen to focus on a different detail within the scene as shown in the display illustrated in FIG. 6. The zoom level (magnification) may be increased so that the details within that region may be seen more clearly as shown in the display illustrated in FIG. 7. A zone may be assigned a user friendly name, for ease of reference when accessing it in the future. In FIG. 8, zone 1 has been renamed “workstation 1.”

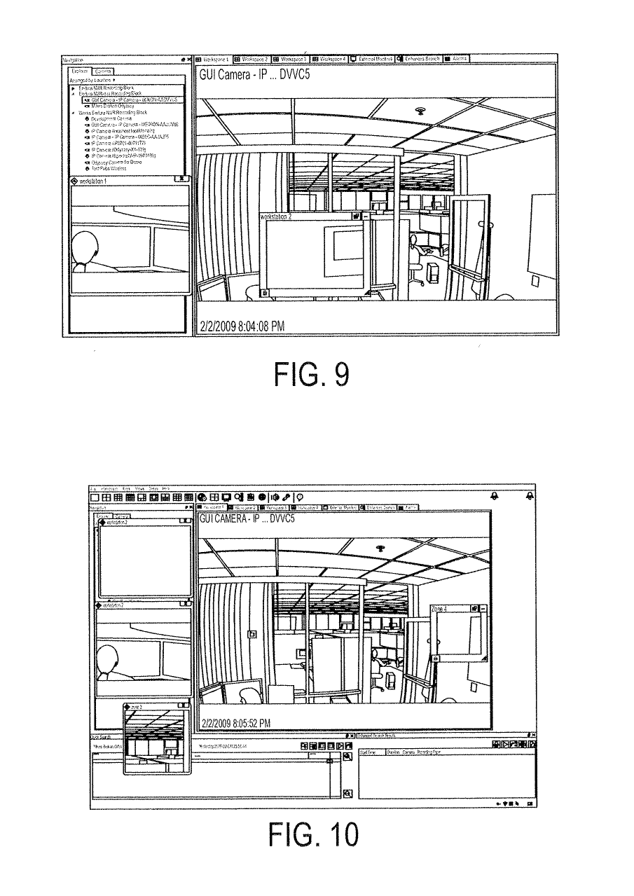

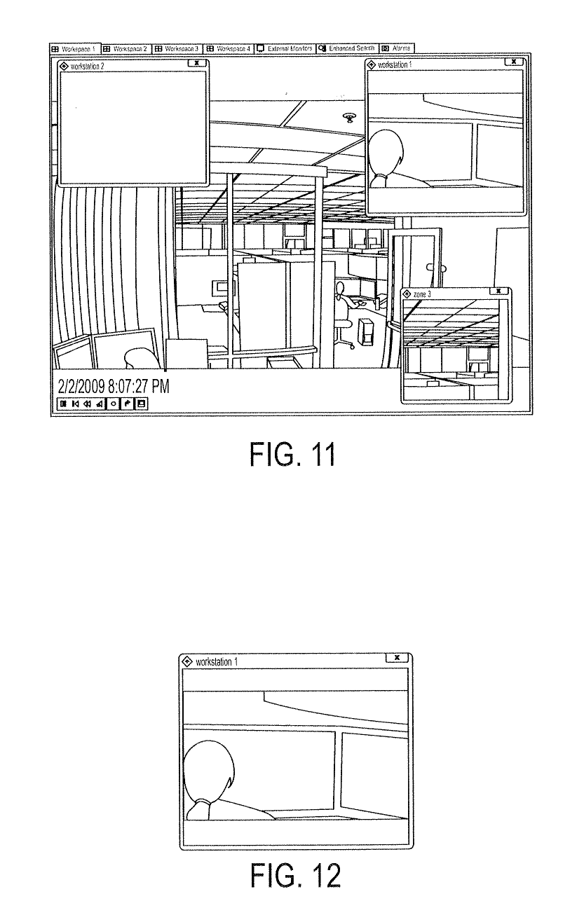

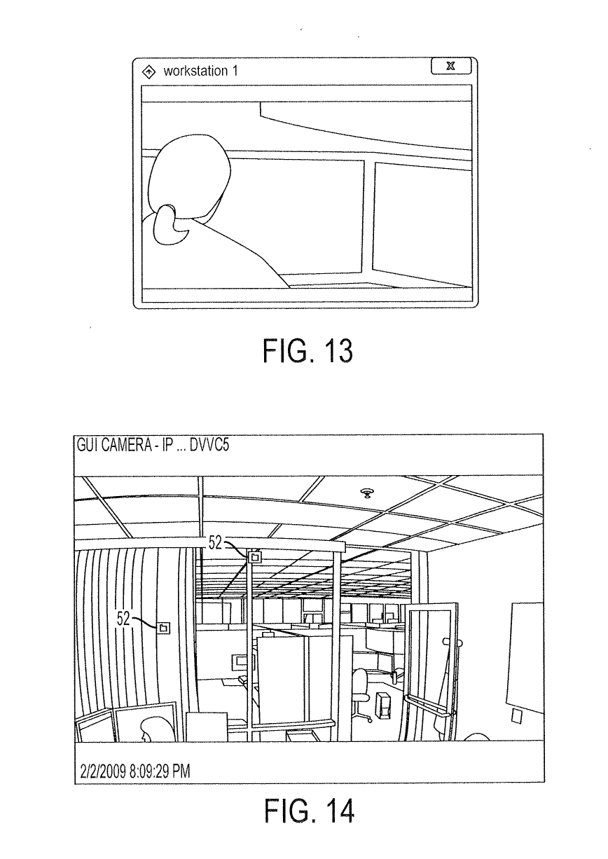

Normally, only one zone may be configured at a time. As soon as a second zone is added or opened, the first zone is minimized. If a user wants to view the zones already configured while creating a new one, he may float the zone by clicking the “float” button in the upper right corner. In FIG. 9 the “workstation 1” zone has been floated to the left side of the monitor, while the user works on configuring a “workstation 2” zone. All of these zones may be floated, both in configuration and in live monitoring mode. The zone windows may appear on top of the primary video view, on another part of the user interface or on a secondary monitor if one is attached. FIG. 10 shows a display in which a user who has three existing zones open while configuring a fourth zone. FIG. 11 shows the windows floating on top of the primary video, in live monitoring mode, once the zones have been configured. In live monitoring mode, zone windows may be resized, but the aspect ratio of the video is protected. In FIG. 13 the user has reduced the height of the window shown in FIG. 12, to eliminate the extra black padding around the video.

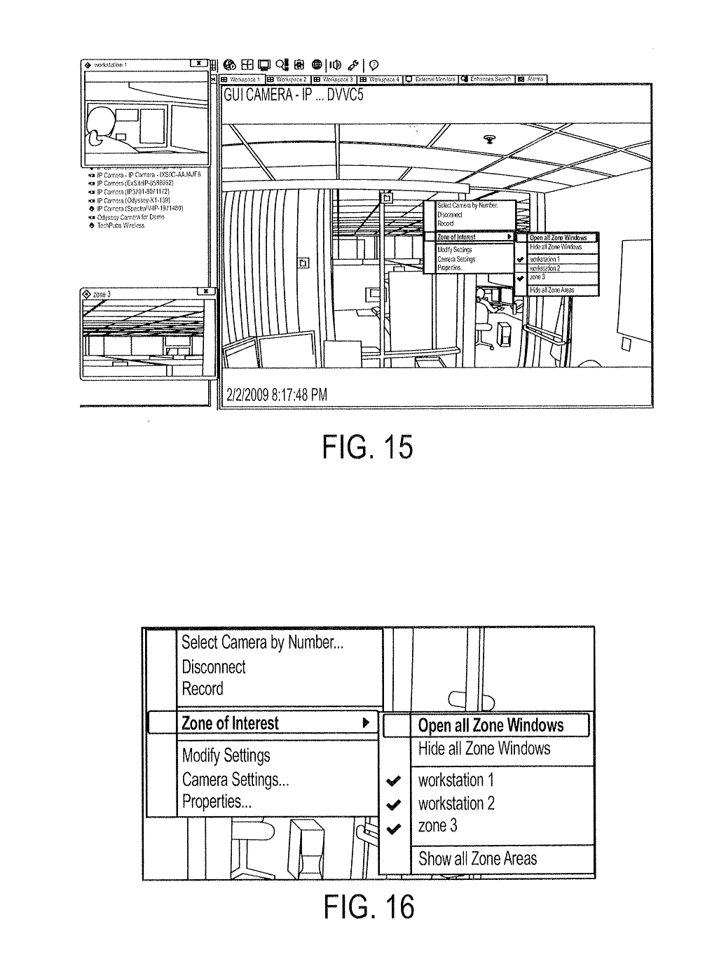

In live monitoring mode, the user has the option to show or hide the zone indicators. These are the small folder icons 52 that mark where a zone has been configured as shown in FIG. 14. The zone windows themselves may be shown or hidden. To open a specific zone window, the user may click one of the zone indicator icons 52 on the screen or select a zone window from the right-click (context) menu as shown in FIG. 15. The user might also want to Open All or Hide All Zone Windows; this can also be accomplished through the right-click menu, as shown in FIG. 16.

The present invention utilizes a pipeline which is a set of objects that work together to process a media stream, such as the high-definition video stream received from a megapixal camera. The pipeline consists of a chain of processing elements, such as processes, threads, coroutines and so forth. The output of each processing element is provided as the input to the next processing element in the pipeline. The pipeline is connected to an input source, such as network 12 in FIG. 1, which is an object that provides media to the pipeline and an output device, such as video display 38 in FIG. 2, where a stream can be output or rendered. The pipeline objects are arranged in stages with each object specializing at a specific task. Video frame data flows from one stage to the next until all frames are rendered.

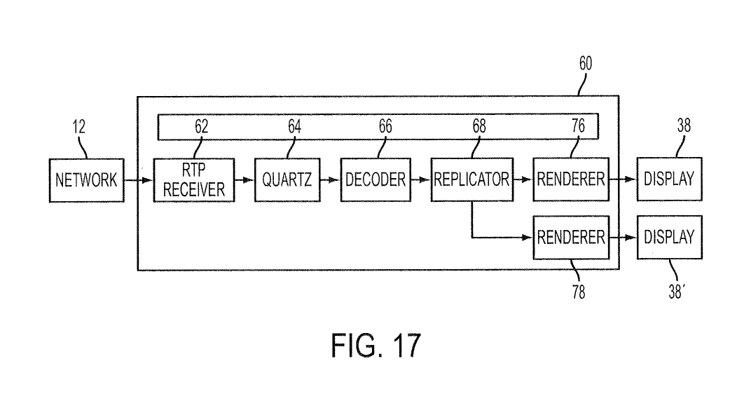

A pipeline 60 for implementing one embodiment of the present invention is shown in FIG. 17. The media processing framework of pipeline 60 comprises an RTP receiver 62 connected to network 12 for receiving a stream of RTP video frames. The output of RTP receiver 62 is provided to quartz media object 64 that regulates frame output and ensures smooth frame rates, as well as other functions. The output of quartz media object 64 is provided to decoder object 66 which takes a compressed frame and converts it to, for example, a raw YUV420p frame. For example, decoder object 66 could utilize Intel® Integrated Performance Primitives, which is a library of software functions for multimedia data processing, as a tool for conversion. The Y stands for the luma component, i.e., the brightness, and the U and V stand for chrominance, i.e., color components. YUV420p is a format in which the Y, U, and V values are grouped together instead of being interspersed so that the image becomes much more compressible. When given an array of an image in the YUV420p format, all the Y values come first, followed by all the U values, followed finally by all the V values.

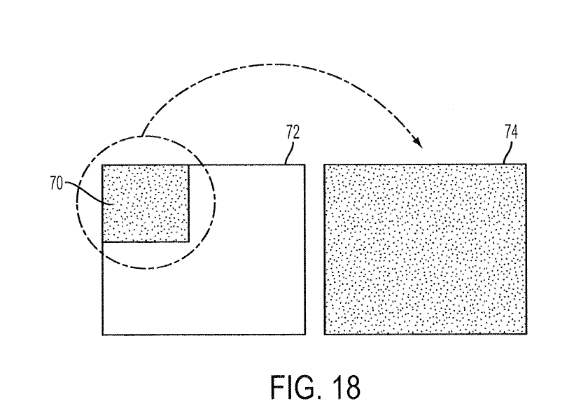

The output of decoder object 66 is provided to replicator object 68 which replicates the data component in the pipeline without adding another pipeline and without impacting the normal operation of the media processing framework pipeline. If a zone of interest is chosen by a user interacting with the graphical user interface as described with reference to FIGS. 3-16, then replicator object 68 can be used to render the zone of interest in a scene in a separate window simultaneously as illustrated in FIG. 18. Zone of interest 70 that was selected in the upper left-hand corner of video scene 72 illustrated by the block on the left has been replicated in a separate window 74 indicated by the box on the right. Replicator object 68 duplicates the data component by copying a section of the rendered frame and displaying it on its own 3D object on the video hardware, for example graphics card 46 in FIG. 2. Referring to FIG. 17, there is shown an example of a pipeline that processes a video stream from network 12 and renders it using two separate renderer objects 76 and 78. The result is an independent window floating on top of the video scene that can be moved and resized by a user on display 38 or sent to a separate display indicated by display 38′.

The following are sample steps to add an additional output media object on the replicator. These steps are repeated for the number of replications that need to be added in the pipeline.
1. Create and add the media object on the pipeline you want to connect to the replicator, e.g., a renderer media object.

PdAutoRef<MPF::IMediaObject> pRenderMediaObject;
PD_CORE::PdUuid renderObjId(“70D849E3-A4B1-46c1-AD04-

F75BA13D71D7”);

PdAutoRef<IPdUnknown> pIPdUnknownRMO;
pIPdUnknownRMO = pIFactory−>CreateObject(
renderObjId.GetUuid( ) );
pIPdUnknownRMO−>QueryInterface(

MPF::IMediaObject::Uuid( ),(void**)&pRenderMediaObject.Raw( ) );

//ensure the name is unique the pipeline needs it to be unique
std::string renderObjName(“PelcoDirect3DRenderer2”);
_pIPipeline−>AddObject( pRenderMediaObject.Raw( ),

&renderObjName);

2. Query the pipeline for the replicator media object.

PdAutoRef<MPF::IMediaObject> pReplicator;
pReplicator = _pIPipeline−>FindObjectByName(“PelcoReplicator”);
PD_ASSERT(pReplicator .IsEmpty( ) == FALSE);

3. Create a new link on the replicator.

PdAutoRef<MPF::ILink> _pOutputLink;
_pOutputLink=
pReplicator−>AddNewLink(MPF::LINKTYPE_OUTPUT);
PD_ASSERT(_pLink.IsEmpty( ) == FALSE);

4. Keep a reference to the _pOutputLink if you desire to remove the additional output link in the future before the whole pipeline goes away.
5. Get the input link on which you want to connect this output link on the media object created in step 1.

// get the link collection of the recv link media object
PdAutoRef<MPF::ICollection> pRecvLinkCollection;
pRecvLinkCollection = pRenderMediaObject−>GetLinks( );
// get the recv input link
PdAutoRef<IPdUnknown> pUnk;
pUnk = pRecvLinkCollection−>Item(0); // 0 since the
Renderer has only a input link

else ensure the index value

PdAutoRef<MPF::ILink> pInputLink;
pUnk−>QueryInterface(MPF::ILink::Uuid( ),
(void**)&pInputLink.Raw( ));
PD_ASSERT(pInputLink.IsEmpty( ) == FALSE);

6. Connect the link created in step 3 to the link in step 5
   _pIPipeline→Connect(pInputLink, _pOutputLink);
7. Before removing an additional output link make sure you disconnect it.
   _pOutputLink→Disconnect(pInputLink);
8. To remove the link on the replicator
   pReplicator→RemoveLink(_pOutputLink).

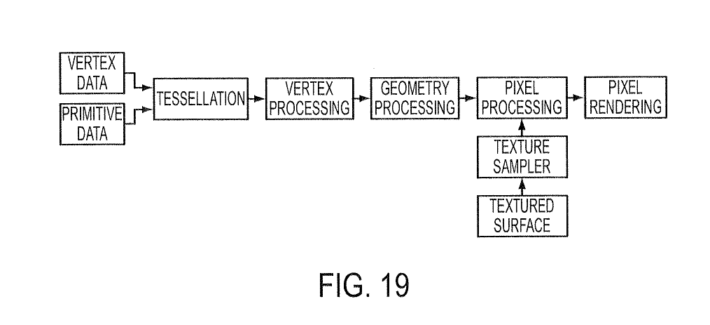

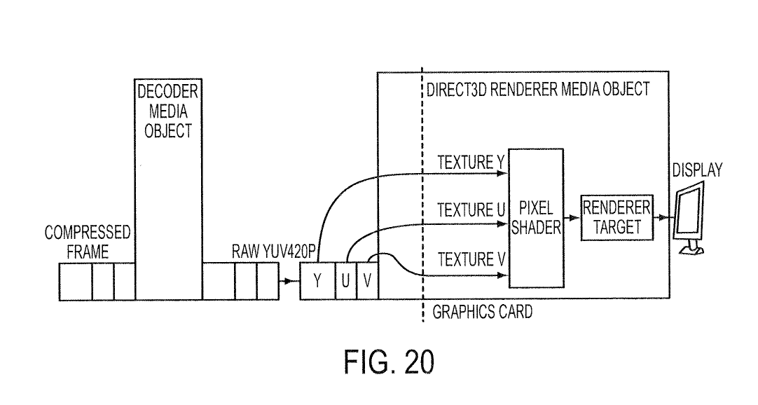

Referring to FIGS. 17, 19, and 20, renderer objects 76 and 78 in pipeline 60 can utilize, for example, Direct3D, which is part of Microsoft's DirectX API, to render three-dimensional graphics. The renderer objects attempt to create a hardware abstraction layer (HAL) device. If the graphics card does not support an appropriate version of a pixel shader, then a reference rasterizer device can be used. The renderer loads the pixel shader and sets the texture, renderer and sampler states. The renderer creates three textures separately for Y, U, and V provided by the decoder. It creates a vertex buffer and populates it with vertex data. The renderer uses the pixel shader to blend the component data into the final rendered frame. An example of one embodiment of a renderer for use in the present invention is illustrated in FIG. 19. FIG. 20 shows in graphical form the process of receiving the compressed video, decoding the compressed video into raw YUV420p, separately texturing the YUV components and providing them to a pixel shader in the renderer and displaying the output of the renderer target on a display.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the foregoing disclosure.

What is claimed is:

1. A method of creating a zone of interest in a video scene comprising the steps of: capturing a video scene; transmitting a captured video scene over a network; receiving a captured video scene from the network; enabling a user to identify a portion of a captured video scene to be a zone of interest; replicating the portion of the captured video scene identified by the user as a zone of interest; rendering the video scene in a first window; and rendering the replicated portion of the captured video scene in a second window independent of the first window.

2. A method as recited in claim 1 wherein said step of enabling a user to identify a portion of a captured video scene to be a zone of interest comprises the step of enabling a user to zoom in in the zone of interest.

3. A method as recited in claim 1 further comprising the step of enabling a user to resize the second window.

4. A method as recited in claim 1 further comprising the step of enabling a user to move the second window.

5. A method as recited in claim 2 further comprising the step of enabling a user to zoom in in the second window.

6. A method as recited in claim 2 further comprising enabling a user to pan inside the second window.

7. A method as recited in claim 2 further comprising enabling a user to tilt inside the second window.

8. A method as recited in claim 2 further comprising enabling a user to save a zone of interest selected by a user.

9. A method as recited in claim 9 further comprising enabling a user to save a zoom setting selected by a user for a zone of interest.

10. A method as recited in claim 1 further comprising the step of providing an icon in the first window indicating a location of an identified zone of interest.

11. A method as recited in claim 10 further comprising enabling a user to open a window for an identified zone of interest by interacting with an icon in the first window.
